(19) United States
(12) Patent Application Publication
(10) Pub. No.: US 2014/0247259 A1
(43) Pub. Date: Sep. 4, 2014

(54) LIQUID CRYSTAL DISPLAY DEVICE, AND DRIVE METHOD FOR LIQUID CRYSTAL PANEL

(71) Applicant: Mitsuaki Hirata, Osaka-shi (JP)

(72) Inventor: Mitsuaki Hirata, Osaka-shi (JP)

(73) Assignee: SHARP KABUSHIKI KAISHA, Osaka-shi, Osaka (JP)

(21) Appl. No.: 14/342,613

(22) PCT Filed: Sep. 3, 2012
(86) PCT No.: PCT/JP2012/072391

§ 371 Date: Mar. 4, 2014

(30) Foreign Application Priority Data
Sep. 6, 2011 (JP) 2011-194198

(51) Int. Cl. G09G 3/36

(52) U.S. Cl. CPC G09G 3/3677
USPC 345/214; 345/98

(57) ABSTRACT

In a case where two-lines simultaneous writing is carried out in a CS control pixel-division-type liquid crystal panel including: a first scanning signal line and a second scanning signal lines (G2, G3) which are adjacent to each other; a third scanning signal line (G49) which is not adjacent to the first scanning signal line; and a first pixel, a second pixel, and a third pixel connected to the first scanning signal line, the second scanning signal line, and the third scanning signal lines, respectively, the first pixel receives a data signal from the first data signal line, the second and third pixels receive a data signal from the second data signal line, and the first and third scanning signal lines (G2, G49) are simultaneously selected. This makes it possible to suppress transverse lines of display unevenness of a liquid crystal display device.

### TECHNICAL FIELD

The present invention relates to a driving technique for a liquid crystal panel.

### BACKGROUND ART

Patent literature 1 discloses the following technique (pixel division driving): two subpixels are provided in one pixel (corresponding to one primary color) of a liquid crystal panel; and when halftone is displayed, these two subpixels are caused to have respective different luminances by controlling potentials of CS wires. This pixel division driving improves viewing angle characteristics of the liquid crystal panel.

Patent Literature 1 also discloses the following technique (two-lines simultaneous selection driving): two data signal lines are provided for one pixel column; and two adjacent scanning signal lines are simultaneously selected. This two-lines simultaneous selection driving allows fast scan of the liquid crystal panel.

### CITATION LIST

### Patent Literature

Patent Literature 1
PCT International Application Publication No. WO2009/084331 (A1)

### SUMMARY OF INVENTION

### Technical Problem

The inventor found that transverse lines of display unevenness are often perceivable if the pixel division driving and the two-lines simultaneous selection driving are employed in a liquid crystal panel in which one CS wire is shared by two adjacent pixel rows (see Patent Literature 1). It is considered that the reason therefor is as follows. A retention capacitor wire CSL1 is affected by feed-through voltages of a pixel electrode d1 and a pixel electrode D2 when a transistor T2 is turned off, whereas a retention capacitor wire CSL2 is affected only by a feed-through voltage of a pixel electrode D3 when a transistor T3 is turned off. Therefore, a ripple that occurs in the retention capacitor wire CSL1 when the transistor T2 is turned off and a ripple that occurs in the retention capacitor wire CSL2 when the transistor T3 is turned off are different in magnitude from each other (and this causes a luminance difference between a subpixel corresponding to the pixel electrode D2 and a subpixel corresponding the pixel electrode D3) (see FIGS. 17 and 18).

One of objects of the present invention is to prevent such transverse lines of display unevenness.

### Solution to Problem

A liquid crystal display device of the present invention including: a first scanning signal line and a second scanning signal line which are adjacent to each other; a third scanning signal line which is not adjacent to the first scanning signal line; a first data signal line and a second data signal line; a first pixel, a second pixel, and a third pixel connected to the first scanning signal line, the second scanning signal line, and the third scanning signal line, respectively; and a first retention capacitor wire, a second retention capacitor wire, a third retention capacitor wire, and a fourth retention capacitor wire, wherein the first to third pixels each include a plurality of pixel electrodes, the first pixel with the first retention capacitor wire forms a capacitor, the first and second pixels with the second retention capacitor wire form capacitors, the third pixel with the third and fourth retention capacitor wires forms capacitors, potentials of the first and second retention capacitor wires are separately controlled, potentials of the third and fourth retention capacitor wires are separately controlled, and the first pixel receives a data signal from the first data signal line, the second and third pixels receive a data signal from the second data signal line, and the first and third scanning signal lines are simultaneously selected.

With such a configuration in which the first scanning signal line and the third scanning signal line which is not adjacent to the first scanning signal line are simultaneously selected, it is possible to reduce a ripple that occurs in the second retention capacitor wire when the simultaneous selection of the first and third scanning signal lines ends so that the ripple is smaller than that in the case where, for example, the first and second scanning signal lines adjacent to each other are simultaneously selected. This makes it possible to suppress transverse lines of display unevenness.

### Advantageous Effects of Invention

As described above, the present invention makes it possible to suppress transverse lines of display unevenness.

### BRIEF DESCRIPTION OF DRAWINGS

FIG. 1 is a timing chart showing how to drive a liquid crystal panel of Example 1 (first half of scanning).

FIG. 2 is a timing chart showing how to drive the liquid crystal panel of Example 1 (second half of scanning).

FIG. 3 is a schematic view showing how to drive the liquid crystal panel of Example 1.

FIG. 4 is a schematic view showing how retention capacitor wires and stem wires are connected in the liquid crystal panel of Example 1.

FIG. 5 is a block diagram illustrating an example of a configuration of a liquid crystal display device of Example 1.

FIG. 6 is a schematic view illustrating a part of the configuration of the liquid crystal panel of Example 1.

FIG. 7 is a timing chart showing how to drive a liquid crystal panel of Example 2 (first half of scanning).

FIG. 8 is a timing chart showing how to drive the liquid crystal panel of Example 2 (second half of scanning).

FIG. 9 is a schematic view illustrating how retention capacitor wires and stem wires are connected in the liquid crystal of Example 2.

FIG. 10 is a timing chart showing how to drive a liquid crystal panel of Example 3.

FIG. 11 is a schematic view showing how to drive the liquid crystal panel of Example 3.

FIG. 12 is a timing chart showing how to drive a liquid crystal panel of Example 4 (second half of scanning).

FIG. 13 is a schematic view illustrating how retention capacitor wires and stem wires are connected in the liquid crystal panel of Example 4.

FIG. 14 is a schematic view illustrating a part of a configuration of a liquid crystal panel of Example 5.

FIG. 15 is a schematic view illustrating a part of a configuration of a liquid crystal panel of Example 6.

FIG. 16 is a schematic view showing how to scan a liquid crystal display device of Example 7.

FIG. 17 is a schematic view showing a conventional driving method.

FIG. 18 is a timing chart explaining problems of the conventional driving method.

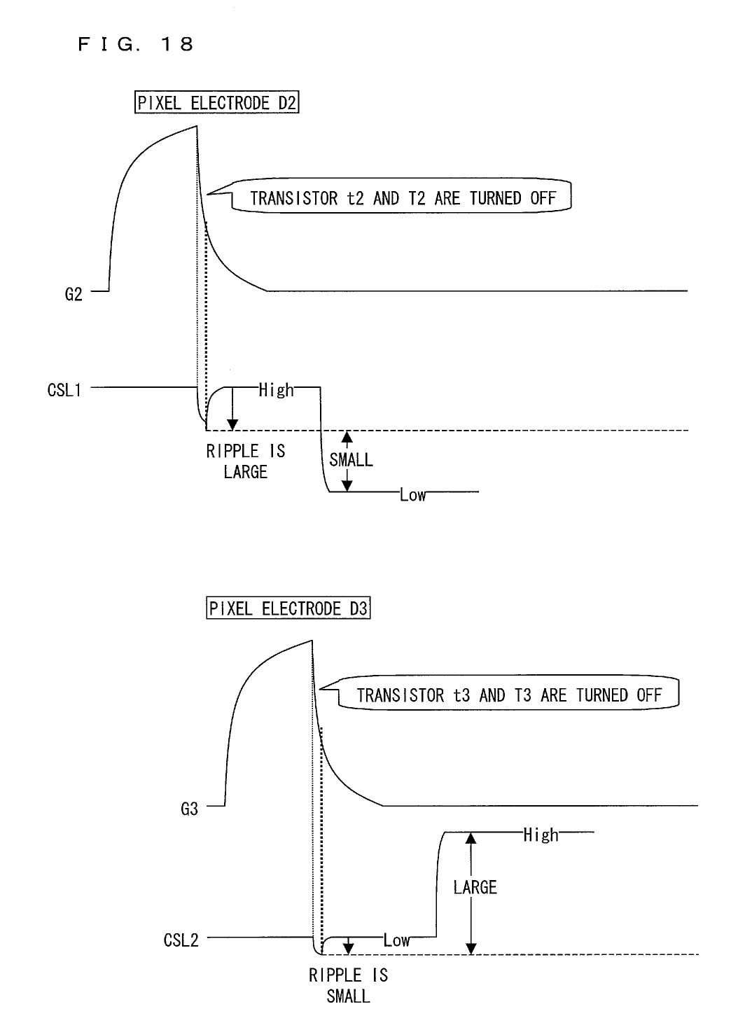

### DESCRIPTION OF EMBODIMENTS

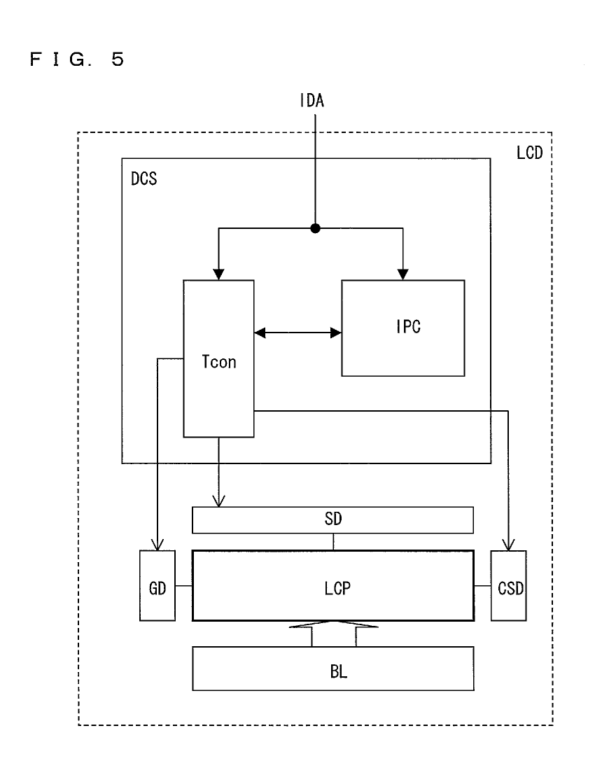

As shown in FIG. 5, a liquid crystal display device LCD of Example 1 includes (i) a liquid crystal panel LCP including scanning signal lines, data signal lines, retention capacitor wires (CS wires), transistors and pixel electrodes, (ii) a backlight BL for irradiating the liquid crystal panel LCP with light, (iii) a gate driver GD for driving the scanning signal lines (supplying gate pulses to the scanning signal lines), (iv) a source driver SD for driving the data signal lines (supplying signal potentials to the data signal lines), (v) a CS driver CSD for controlling potentials of the retention capacitor wires (CS wires) by supplying modulated signals to the retention capacitor wires, and (vi) a display controlling substrate DCS (timing controller substrate) for controlling the gate driver, the source driver, and the CS driver.

The display control substrate DCS includes a timing controller Tcon and an image processing circuit IPC. The timing controller Tcon (i) generates display data, a source control signal, a gate control signal, and a CS control signal from image data IDA in cooperation with the image processing circuit IPC and (ii) supplies the display data and the source control signal to the source driver SD, supplies the gate control signal to the gate driver GD, and supplies the CS control signal to the CS driver CSD.

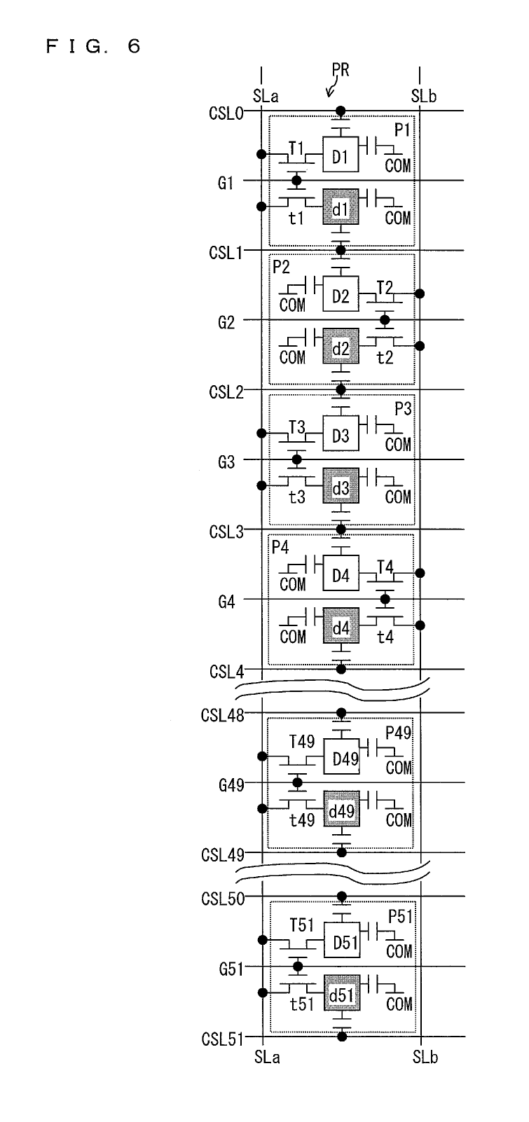

The liquid crystal panel LCP is arranged such that, assuming that a scanning direction is a column direction, (i) one pixel (corresponding to one primary color) includes two pixel electrodes, (ii) two data signal lines are provided in correspondence with one pixel column, and (iii) two adjacent pixel rows share one retention capacitor wire (see FIG. 6).

Specifically, two data signal lines SLa and SLb are provided in correspondence with a pixel column PR, a pixel electrode D1 and a pixel electrode d1 are provided in a pixel P1, the pixel electrode D1 is connected to the data signal line SLa and a scanning signal line G1 via a transistor T1, and the pixel electrode d1 is connected to the data signal line SLa and the scanning signal line G1 via a transistor t1. A pixel electrode D2 and a pixel electrode d2 are provided in a pixel P2 (pixel of the same color as the pixel P1) which is adjacent to the pixel P1 along the column direction, the pixel electrode D2 is connected to the data signal line SLb and a scanning signal line G2 via a transistor T2, while the pixel electrode d2 is connected to the data signal line SLb and the scanning signal line G2 via the transistor t2. Further, a pixel electrode D3 and a pixel electrode d3 are provided to a pixel P3 (pixel having the same color as the pixels P1 and P2) which is adjacent to the pixel P2 in a column direction. The pixel electrode D3 is connected to the data signal line SLa and a scanning signal line G3 via a transistor T3, while the pixel electrode d3 is connected to the data signal line SLa and the scanning signal line G3 via the transistor t3. That is, an odd-numbered pixel in the pixel column PR is connected to the data signal line SLa via a transistor, whereas an even-numbered pixel in the pixel column PR is connected to the data signal line SLb via the transistor.

Furthermore, for example, (i) the retention capacitor wire CSL1, with the pixel electrode d1 of the pixel P1 and the pixel electrode D2 of the pixel P2, forms retention capacitors, (ii) the retention capacitor wire CSL2, with the pixel electrode d2 of the pixel P2 and the pixel electrode D3 of the pixel P3, forms retention capacitors, and (iii) the n-th pixel in the pixel column PR, with the (n−1)-th retention capacitor wire and the n-th retention capacitor wire, forms retention capacitors.

### Example 1

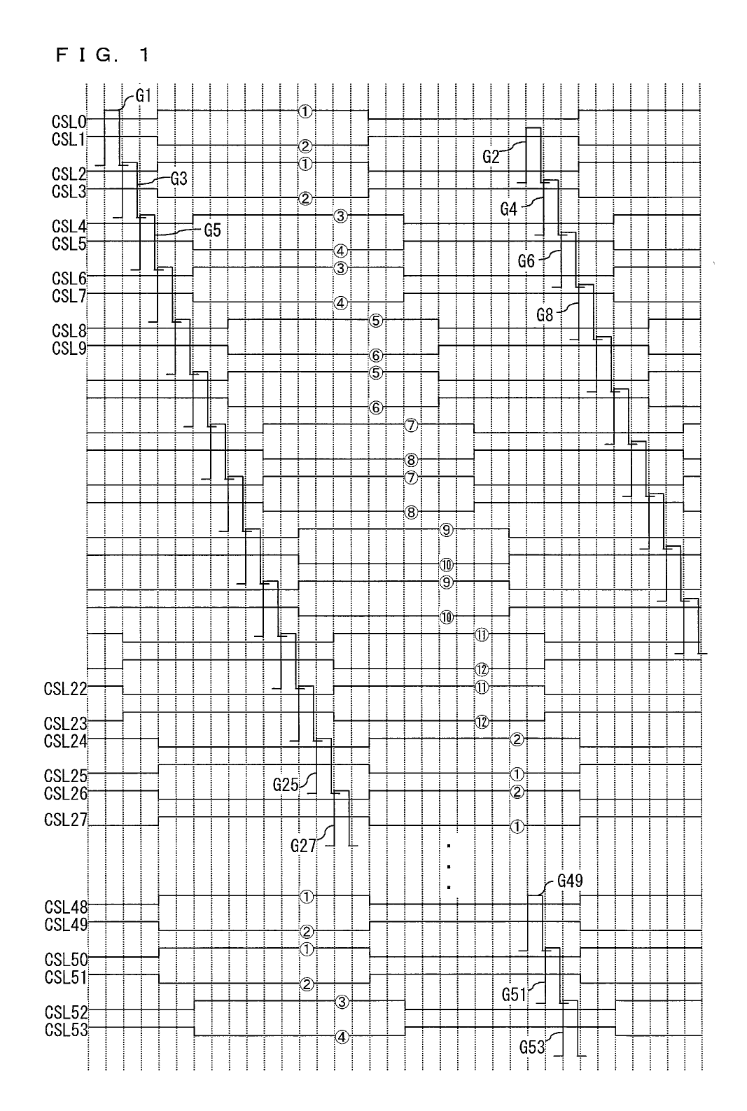

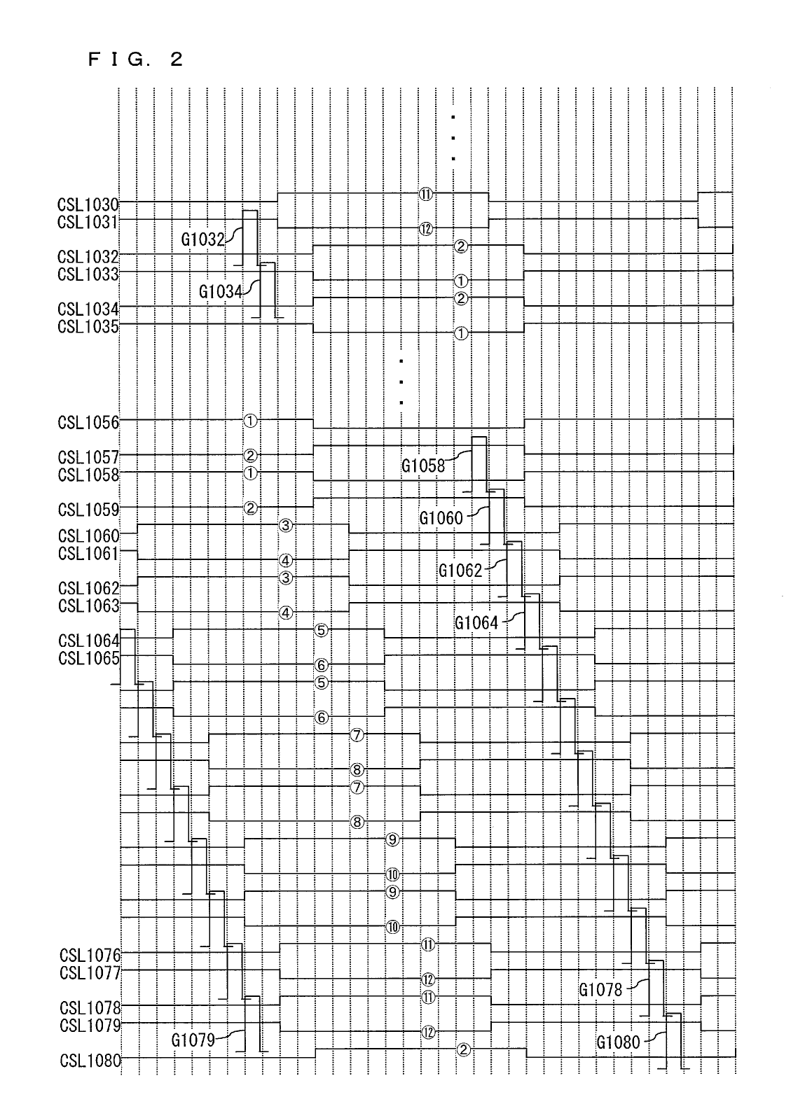

According to Example 1 (it is assumed that the number of scanning signal lines is 1080), odd-numbered scanning signal lines of the scanning signal lines G1 to Gk (e.g., k=48) (i.e., the number of the odd-numbered scanning signal lines is k/2 in total) are sequentially selected one by one. After that, scanning signal lines are sequentially selected in such a manner that a scanning signal line Gi and a scanning signal line Gi+k−1 (i is an even number of 2 to (1080−k)) are simultaneously selected. After that, even-numbered scanning signal lines of the scanning signal lines G1080-k−2 to G1080 (the number of the even-numbered scanning signal lines is k/2 in total) are sequentially selected one by one (see FIGS. 1 to 3).

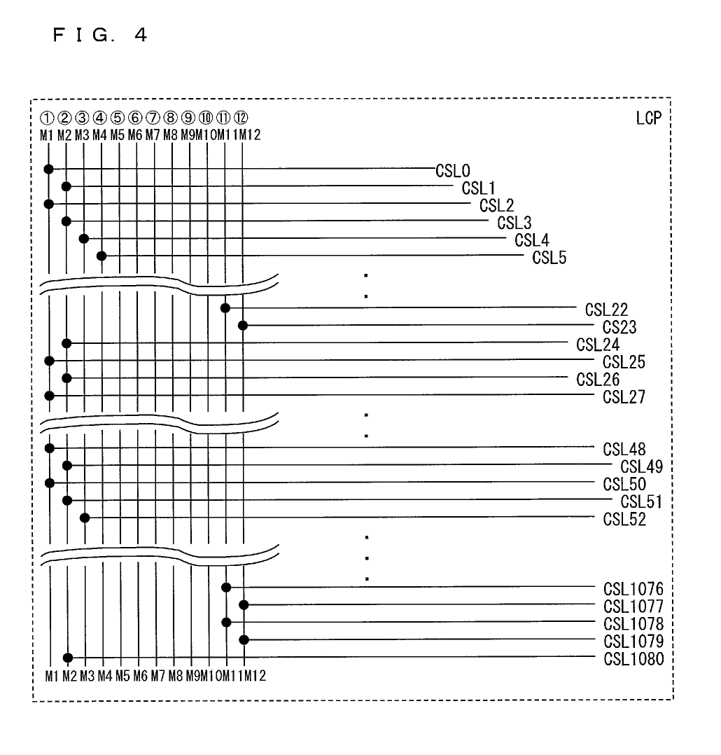

In this arrangement, as shown in FIGS. 1 to 4, 1081 retention capacitor wires CSL0 to CSL1080 are connected to 12 stem wires M1 to M12, and the stem wires M1 to M12 are supplied with modulated signals of 12 different phases. It is assumed that each of these modulated signals is a signal which switches between “High” and “Low” every 12 H (12 horizontal scanning periods) and that the length of k×1 horizontal scanning periods is equal to an even multiple of the cycle (24 H) of the modulated signal.

Specifically, the retention capacitor wires CSL0 to CSL1080 are divided into groups each having k retention capacitor wires (in the case where k=48, there are 23 groups in total; however, the number of retention capacitor wires in the last (23rd) group is 25), and the j-th (j is equal to or smaller than k) retention capacitor wires in the respective groups are connected to the same stem wire and receive in-phase modulated signals. For example, the retention capacitor wires CSL0, CSL48, . . . and CSL1056 (the first retention capacitor wire in each group) are connected to the stem wire M1, and the retention capacitor wires CSL21, CSL69, . . . and CSL1077 (the 22nd retention capacitor wire in each group) are connected to the stem wire M12.

Note that the retention capacitor wires in each of the groups are divided into subgroups each having 4 retention capacitor wires (12 subgroups in total). In one subgroup, the first and third capacitor wires are connected to the same stem wire and receive in-phase modulated signals, the second and fourth retention capacitor wires are connected to the same stem wire and receive in-phase modulated signals, and the first and second retention capacitor wires receive opposite-phase modulated signals. Furthermore, a modulated signal supplied to the m-th (m is 4 or smaller) retention capacitor wire in one subgroup is advanced by 2 H (2 horizontal periods) from a modulated signal supplied to the m-th retention capacitor in the previous subgroup.

Furthermore, a modulated signal supplied to the retention capacitor wire CSL0 changes from “Low” to “High” 3 H (3 horizontal periods) after the scanning signal line G1 starts being selected (scanned), a modulated signal supplied to the retention capacitor wire CSL1 changes from “High” to “Low” 3 H (3 horizontal periods) after the scanning signal line G2 starts being selected (scanned), and a modulated signal supplied to the retention capacitor wire CSL2 changes from “Low” to “High” 3 H (3 horizontal periods) after the scanning signal line G3 starts being selected (scanned).

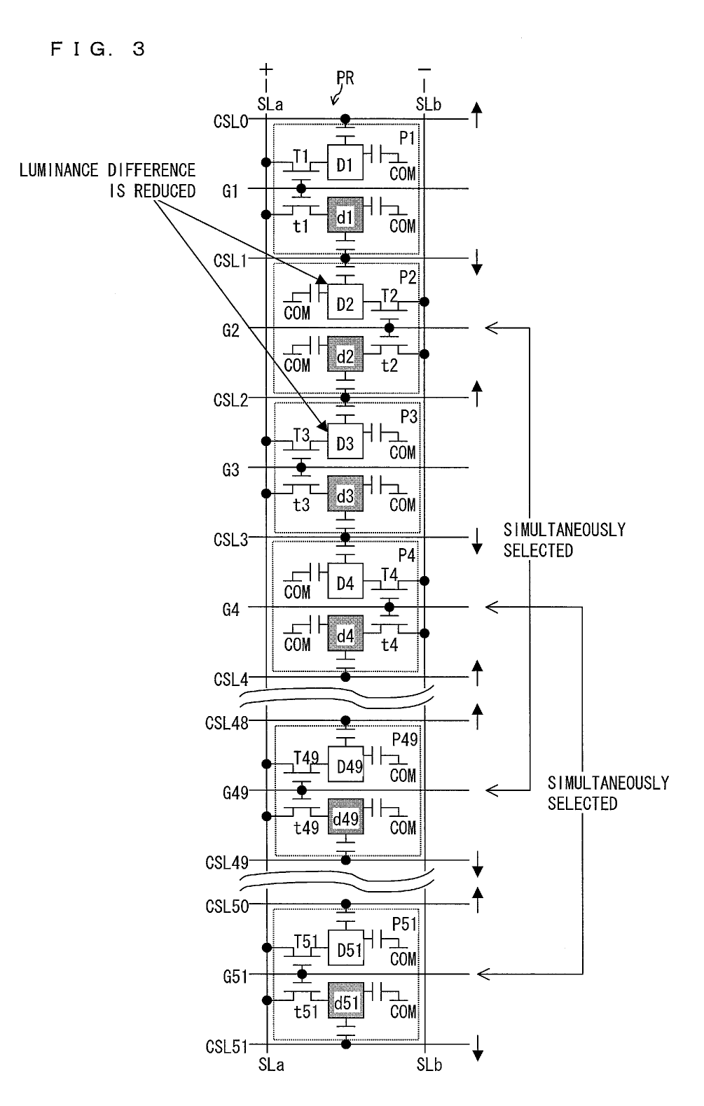

According to Example 1, while the scanning signal line G3 is in a selected state, a positive signal potential is written from the data signal line SLa to the pixel electrode D3 and the pixel electrode d3 of the pixel P3 (see FIG. 3). After that, the retention capacitor wire CSL2 changes from a “Low” state to a “High” state while the retention capacitor wire CSL3 changes from a “High” state to a “Low” state. Accordingly, an effective potential of the pixel electrode D3 becomes higher than the signal potential whereas an effective potential of the pixel electrode d3 becomes lower than the signal potential. As a result, in the pixel P3, a subpixel corresponding to the pixel electrode D3 has a high luminance (light) and a subpixel corresponding to the pixel electrode d3 has a low luminance (dark). This makes it possible to improve viewing angle characteristics of the pixel P3.

Furthermore, according to Example 1, while the scanning signal line G2 and the scanning signal line G49 are both in the selected state, a negative signal potential is written from the data signal line SLb to the pixel electrode D2 and the pixel electrode d2 of the pixel P2, and a positive signal potential is written from the data signal line SLa to a pixel electrode D49 and a pixel electrode d49 of a pixel P49. After that, the retention capacitor wire CSL1 changes from a “High” state to a “Low” state while the retention capacitor wire CSL2 changes from a “Low” state to a “High” state. Accordingly, an effective potential of the pixel electrode D2 becomes lower than the signal potential whereas an effective potential of the pixel electrode d2 becomes higher than the signal potential. As a result, in the pixel P2, a subpixel corresponding to the pixel electrode D2 has a high luminance (light) and a subpixel corresponding to the pixel electrode d2 has a low luminance (dark). This makes it possible to improve viewing angle characteristics of the pixel P2.

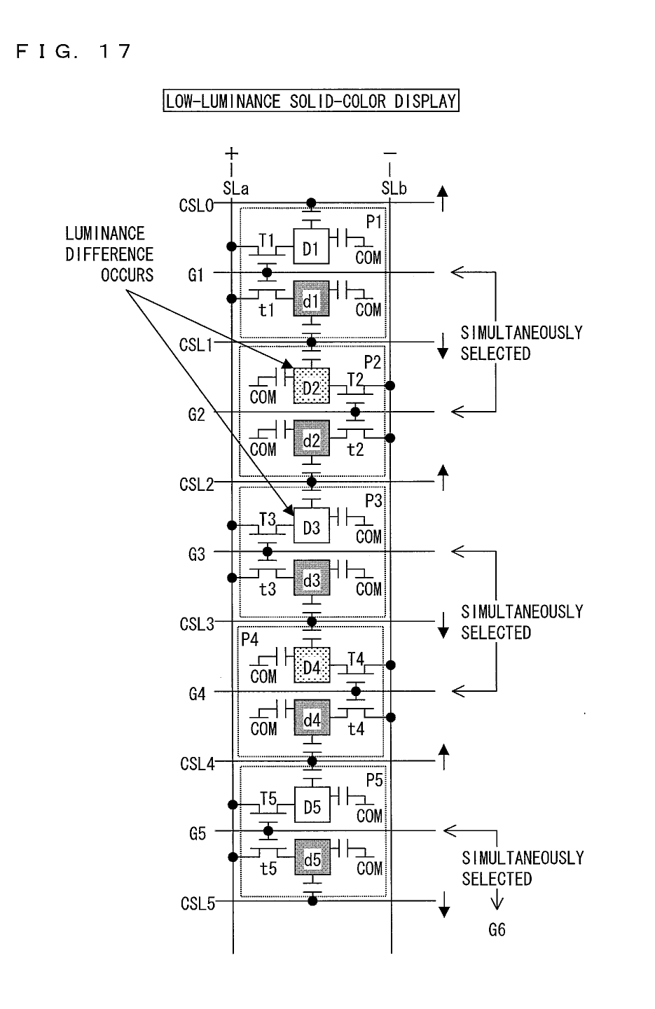

According to Example 1, as shown in FIGS. 1 to 3, the retention capacitor wire CSL1 is affected only by a feed-through voltage of the pixel electrode D2 when the transistor T2 is turned off, and the retention capacitor wire CSL2 is also affected only by a feed-through voltage of the pixel electrode D3 when the transistor T3 is turned off. Accordingly, a ripple that occurs in the retention capacitor wire CSL1 when the transistor T2 is turned off and a ripple that occurs in the retention capacitor wire CSL2 when the transistor T3 is turned off become the same in magnitude, and thus luminance differences (transverse lines of display unevenness) as shown in FIG. 17 can be reduced.

### Example 2

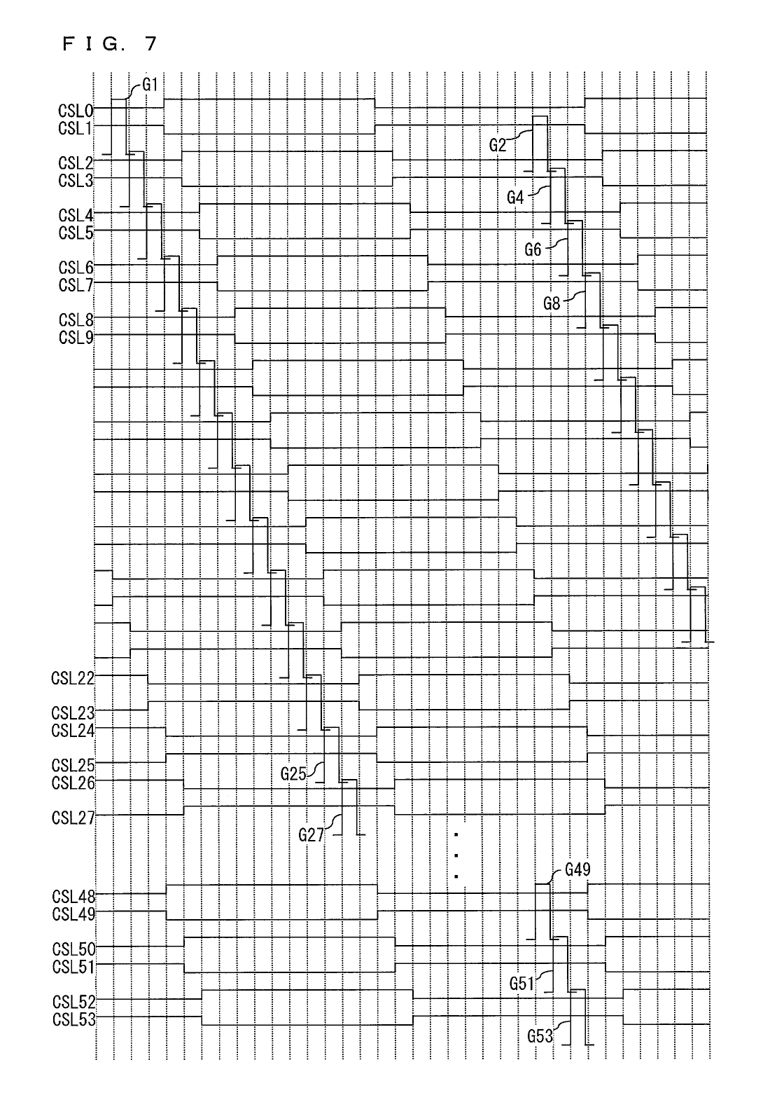

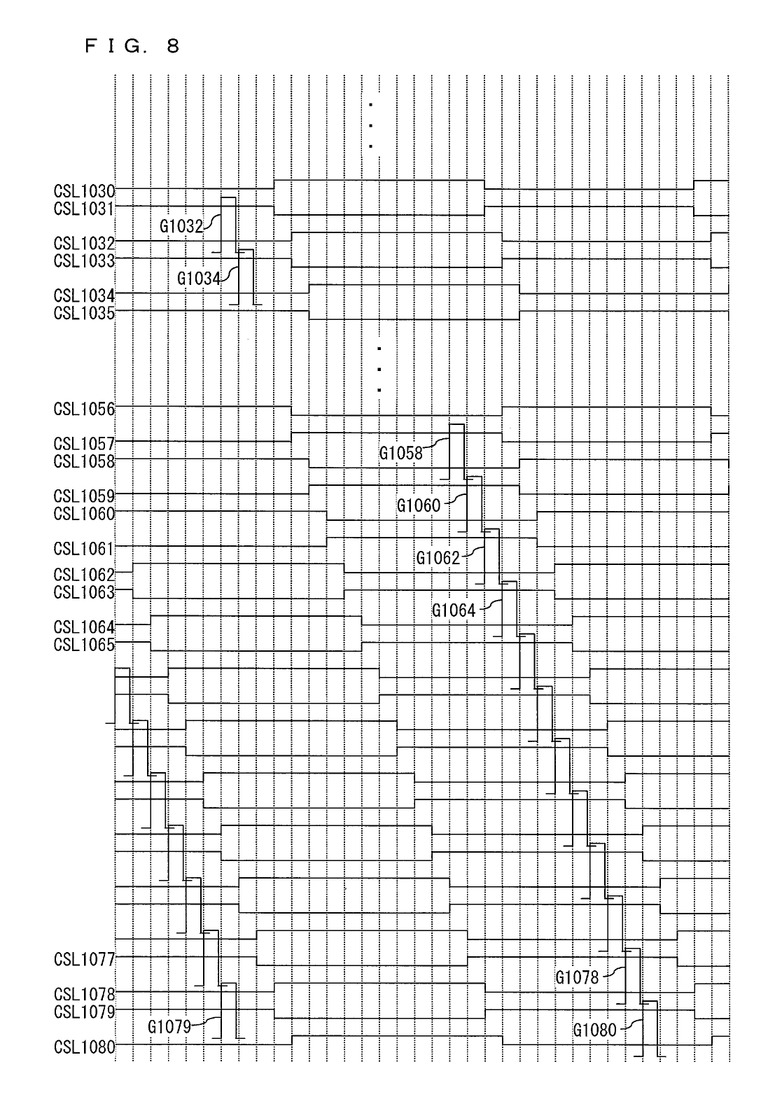

According to Example 2 (it is assumed that the number of scanning signal lines is 1080), odd-numbered scanning signal lines of the scanning signal lines G1 to Gk (e.g., k=48) are sequentially selected one by one. After that, scanning signal lines are sequentially selected in such a manner that a scanning signal line Gi and a scanning signal line Gi+k−1 (i is an even number of 2 to 1080−k) are simultaneously selected. After that, even-numbered scanning signal lines G1080-k−2 to G1080 are sequentially selected one by one (see FIGS. 7 and 8).

In this arrangement, as shown in FIGS. 7 to 9, 1081 retention capacitor wires CSL0 to CSL1080 are connected to 24 stem wires M1 to M24, and the stem wires M1 to M24 are supplied with modulated signals of 24 different phases. It is assumed that each of these modulated signals is a signal which switches between “High” and “Low” every 12 H (12 horizontal scanning periods) and that the length of k×1 horizontal scanning periods is equal to an even multiple of the cycle (24 H) of the modulated signal.

Specifically, the retention capacitor wires CSL0 to CSL1080 are divided into groups each having k retention capacitor wires (in the case where k=48, there are 23 groups in total; however, the number of retention capacitor wires in the last (23rd) group is 25), and the j-th (j is equal to or smaller than k) retention capacitor wires in the respective groups are connected to the same stem wire and receive in-phase modulated signals. For example, the retention capacitor wires CSL0, CSL48, . . . and CSL1056 (the first retention capacitor wire in each group) are connected to the stem wire M1, and the retention capacitor wires CSL23, CSL71, . . . and CSL1079 (the 24th retention capacitor wire in each group) are connected to the stem wire M24.

Note that the retention capacitor wires in each of the groups are divided into subgroups each having 2 retention capacitor wires (24 subgroups in total). In one subgroup, the first and second capacitor wires receive opposite-phase modulated signals. Furthermore, a modulated signal supplied to the m-th (m is 2 or smaller) retention capacitor wire in one subgroup is advanced by 1 H (1 horizontal period) from a modulated signal supplied to the m-th retention capacitor in the previous subgroup.

Furthermore, a modulated signal supplied to the retention capacitor wire CSL0 changes from “Low” to “High” 3 H (3 horizontal periods) after the scanning signal line G1 starts being selected (scanned), a modulated signal supplied to the retention capacitor wire CSL1 changes from “High” to “Low” 3 H (3 horizontal periods) after the scanning signal line G2 starts being selected (scanned), and a modulated signal supplied to the retention capacitor wire CSL2 changes from “Low” to “High” 3 H (3 horizontal periods) after the scanning signal line G3 starts being selected (scanned).

### Example 3

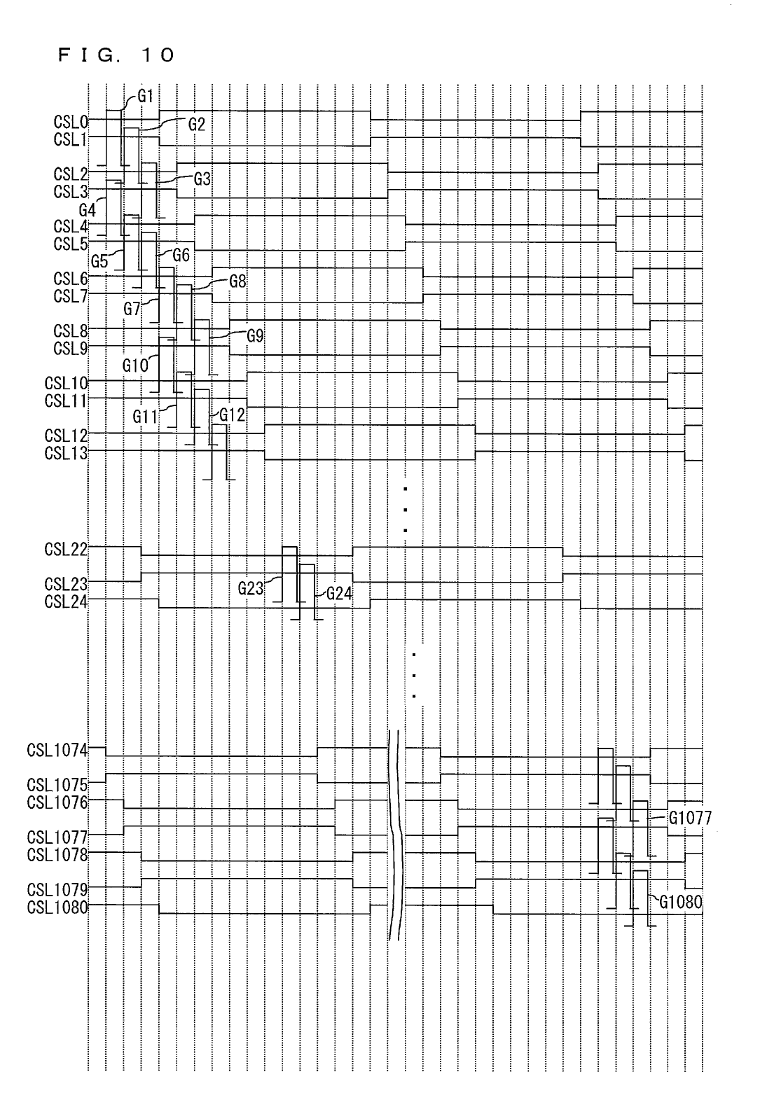

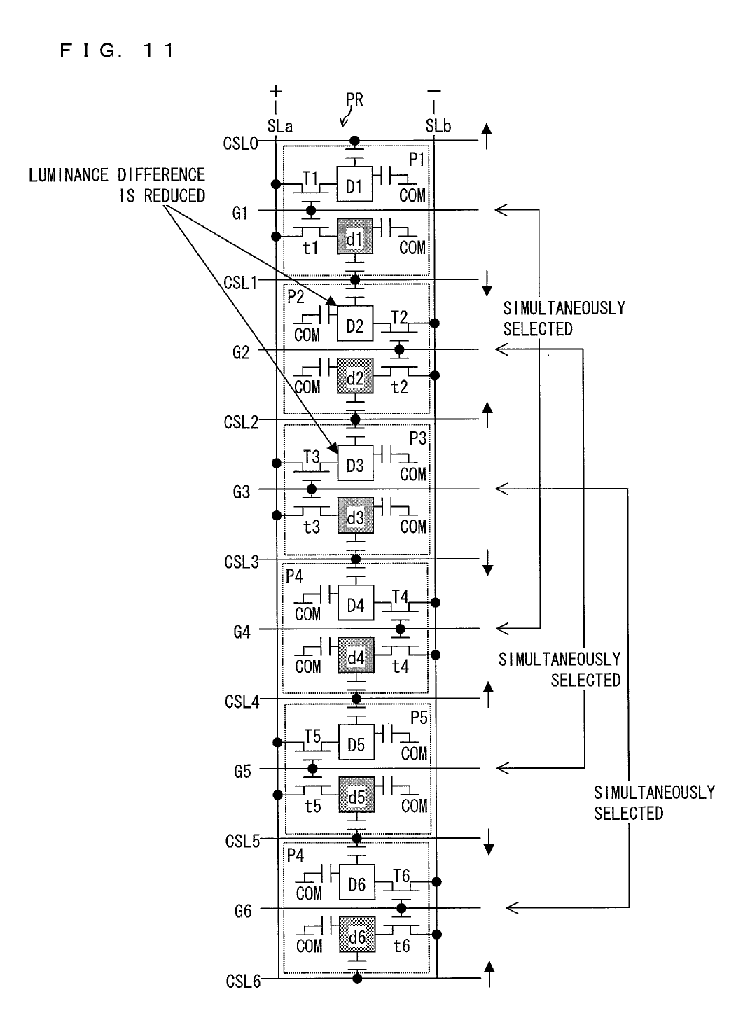

According to Example 3 (it is assumed that the number of scanning signal lines is 1080), as shown in FIGS. 10 and 11, scanning signal lines are sequentially selected such that (i) scanning signal lines Gα+1 (α is a multiple of 6 including 0) and Gα+4 are simultaneously selected, (ii) scanning signal lines Gα+2 and Gα+5 are simultaneously selected, and then (iii) scanning signal lines Gα+3 and Gα+6 are simultaneously selected. For example, scanning signal lines G1 and G4 are simultaneously selected, scanning signal lines G2 and G5 are simultaneously selected, and then scanning signal lines G3 and G6 are simultaneously selected (α=0). Next, scanning signal lines G7 and G10 are simultaneously selected, scanning signal lines G8 and G11 are simultaneously selected, and then scanning signal lines G9 and G12 are simultaneously selected (α=6).

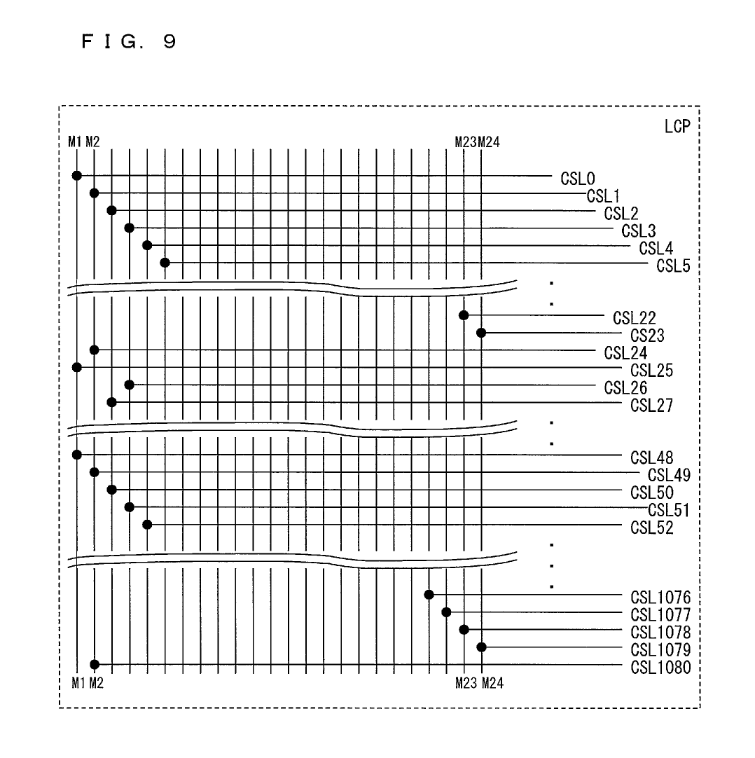

In this arrangement, as shown in FIGS. 9 to 11, 1081 retention capacitor wires CSL0 to CSL1080 are connected to 24 stem wires M1 to M24, and the stem wires M1 to M24 are supplied with modulated signals of 24 different phases.

Specifically, the retention capacitor wires CSL0 to CSL1080 are divided into groups each having k retention capacitor wires (in the case where k=48, there are 23 groups in total; however, the number of retention capacitor wires in the last (23rd) group is 25), and the j-th (j is equal to or smaller than k) retention capacitor wires in the respective groups are connected to the same stem wire and receive in-phase modulated signals. For example, the retention capacitor wires CSL0, CSL48, . . . and CSL1056 (the first retention capacitor wire in each group) are connected to the stem wire M1, and the retention capacitor wires CSL23, CSL71 . . . and CSL1079 (the 24th retention capacitor wire in each group) are connected to the stem wire M24. It is assumed that each of these modulated signals is a signal which switches between “High” and “Low” every 12 H (12 horizontal scanning periods) and that the length of k×1 horizontal scanning periods is equal to an even multiple of the cycle (24 H) of the modulated signal.

Note that the retention capacitor wires in each of the groups are divided into subgroups each having 2 retention capacitor wires (24 subgroups in total). In one subgroup, the first and second capacitor wires receive opposite-phase modulated signals. Furthermore, a modulated signal supplied to the m-th (m is 2 or smaller) retention capacitor wire in one subgroup is advanced by 1 H (1 horizontal period) from a modulated signal supplied to the m-th retention capacitor in the previous subgroup.

Furthermore, a modulated signal supplied to the retention capacitor wire CSL0 changes from “Low” to “High” 3 H (3 horizontal periods) after the scanning signal line G1 starts being selected (scanned), a modulated signal supplied to the retention capacitor wire CSL1 changes from “High” to “Low” 2 H (2 horizontal periods) after the scanning signal line G2 starts being selected (scanned), and a modulated signal supplied to the retention capacitor wire CSL2 changes from “Low” to “High” 2 H (2 horizontal periods) after the scanning signal line G3 starts being selected (scanned).

According to Example 3, as shown in FIG. 11, while the scanning signal line G2 and the scanning signal line G5 are in the selected state, a negative signal potential is written from the data signal line SLb to the pixel electrode D2 and the pixel electrode d2 of the pixel P2, and a positive signal potential is written from the data signal line SLa to a pixel electrode D5 and a pixel electrode d5 of a pixel P5. After that, the retention capacitor wire CSL1 changes from a “High” state to a “Low” state, while the retention capacitor wire CSL2 changes from a “Low” state to a “High” state. Accordingly, an effective potential of the pixel electrode D2 becomes lower than the signal potential whereas an effective potential of the pixel electrode d2 becomes higher than the signal potential. As a result, in the pixel P2, a subpixel corresponding to the pixel electrode D2 has a high luminance (light) and a subpixel corresponding to the pixel electrode d2 has a low luminance (dark). This makes it possible to improve viewing angle characteristics of the pixel P2.

Furthermore, according to Example 3, while the scanning signal line G3 and the scanning signal line G6 are in the selected state, a positive signal potential is written from the data signal line SLa to the pixel electrode D3 and the pixel electrode d3 of the pixel P3, and a negative signal potential is written from the data signal line SLb to a pixel electrode D6 and a pixel electrode d6 of a pixel P6. After that, the retention capacitor wire CSL2 changes from a “Low” state to a “High” state while the retention capacitor wire CSL3 changes from a “High” state to a “Low” state. Accordingly, an effective potential of the pixel electrode D3 becomes higher than the signal potential whereas an effective potential of the pixel electrode d3 becomes lower than signal potential. As a result, in the pixel P3, a subpixel corresponding to the pixel electrode D3 has a high luminance (light) and a subpixel corresponding to the pixel electrode d3 has a low luminance (dark). This makes it possible to improve viewing angle characteristics of the pixel P3.

According to Example 3, as shown in FIGS. 10 and 11, the retention capacitor wire CSL1 is affected only by a feed-through voltage of the pixel electrode D2 when the transistor T2 is turned off, and the retention capacitor wire CSL2 is also affected only by a feed-through voltage of the pixel electrode D3 when the transistor T3 is turned off. Accordingly, a ripple that occurs in the retention capacitor wire CSL1 when the transistor T2 is turned off and a ripple that occurs in the retention capacitor wire CSL2 when the transistor T3 is turned off become the same in magnitude, and thus luminance differences (transverse lines of display unevenness) as shown in FIG. 17 can be reduced.

### Example 4

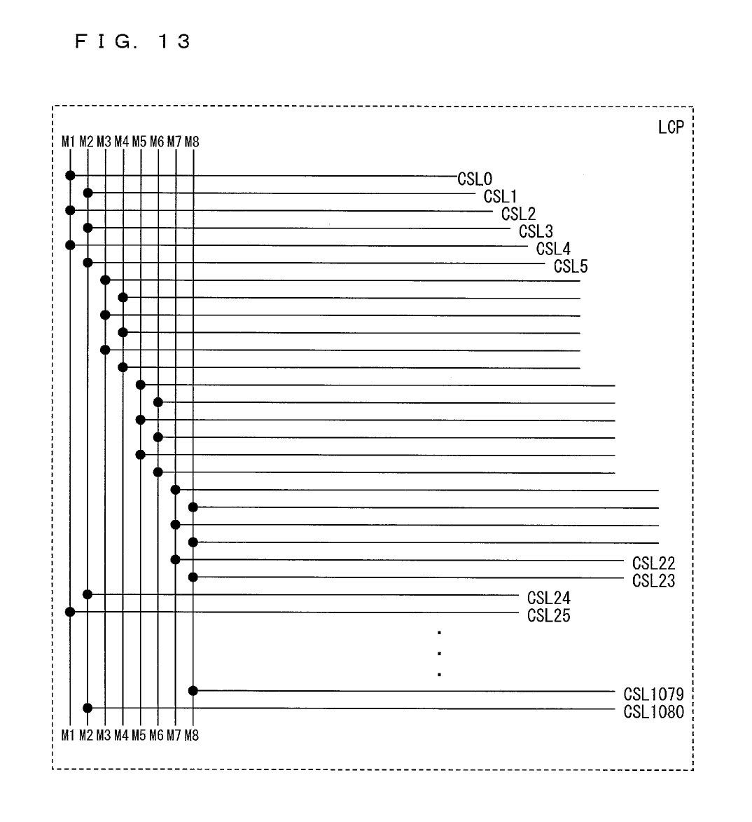

According to Example 3 (it is assumed that the number of scanning signal lines is 1080), as shown in FIGS. 11 to 13, scanning signal lines are sequentially selected such that (i) scanning signal lines Gα+1 (α is a multiple of 6 including 0) and Gα+4 are simultaneously selected, (ii) scanning signal lines Gα+2 (α is a multiple of 6 including 0) and Gα+5 are simultaneously selected, and then (iii) scanning signal lines Gα+3 (α is a multiple of 6 including 0) and Gα+6 are simultaneously selected. For example, the scanning signal line G1 and a scanning signal line G4 are simultaneously selected, the scanning signal lines G2 and G5 are simultaneously selected, and then the scanning signal lines G3 and G6 are simultaneously selected (α=0). Next, the scanning signal lines G7 and G10 are simultaneously selected, the scanning signal line G8 and G11 are simultaneously selected, and then the scanning signal lines G9 and G12 are simultaneously selected (α=6).

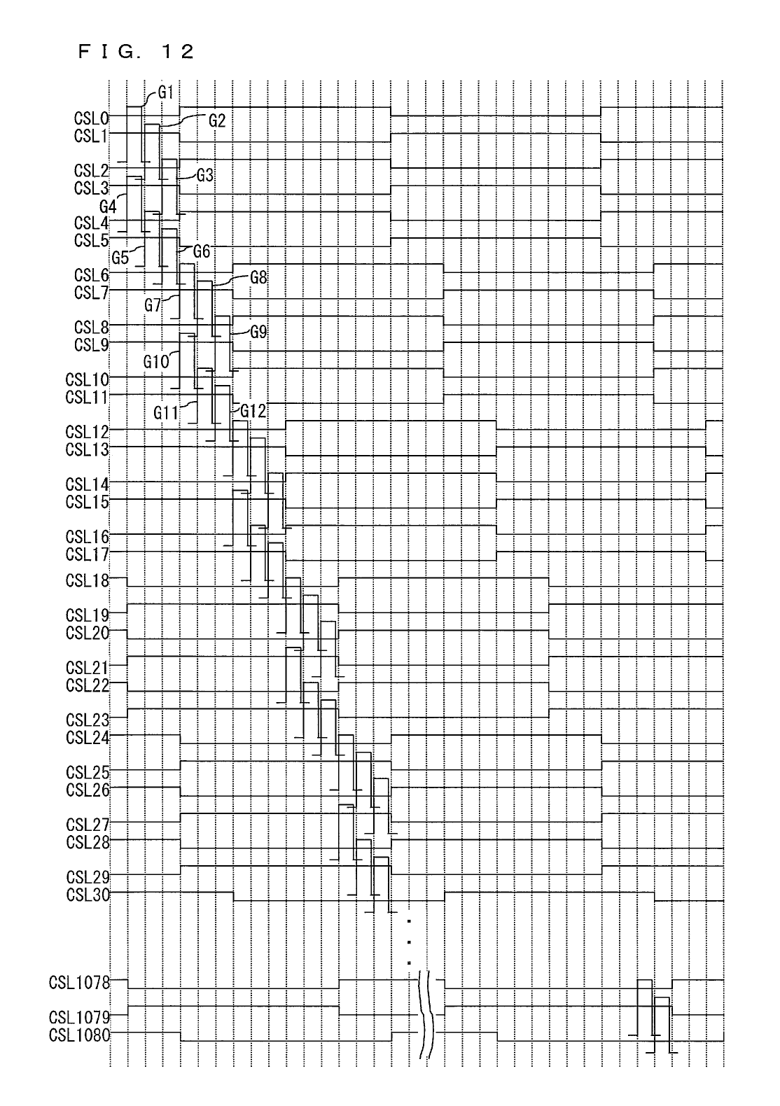

In Example 4, as shown in FIGS. 12 and 13, 1081 retention capacitor wires CSL0 to CSL1080 are connected to 8 stem wires M1 to M8, and the stem wires M1 to M8 are supplied with modulated signals of 8 different phases.

Specifically, the retention capacitor wires CSL0 to CSL1080 are divided into groups each having k retention capacitor wires (in the case where k=48, there are 23 groups in total; however, the number of retention capacitor wires in the last (23rd) group is 25), and the j-th (j is equal to or smaller than k) retention capacitor wires in the respective groups are connected to the same stem wire and receive in-phase modulated signals. For example, the retention capacitor wires CSL0, CSL48, . . . and CSL1056 (the first retention capacitor wire in each group) are connected to the stem wire M1, and the retention capacitor wires CSL19, CSL67 . . . and CSL1075 (the 20th retention capacitor wire in each group) are connected to the stem wire M8. It is assumed that each of these modulated signals is a signal which switches between “High” and “Low” every 12 H (12 horizontal scanning periods) and that the length of k×1 horizontal scanning periods is equal to an even multiple of the cycle (24 H) of the modulated signal.

Note that the retention capacitor wires in each of the groups are divided into subgroups each having 6 retention capacitor wires (8 subgroups in total). In one subgroup, the first, third, and fifth capacitor wires are connected to the same stem wire and receive in-phase modulated signals, the second, fourth, sixth retention capacitor wires are connected to the same stem wire and receive in-phase modulated signals, and the first and second retention capacitor wires receive opposite-phase modulated signals. Furthermore, a modulated signal supplied to the m-th (m is 6 or smaller) retention capacitor wire in one subgroup is advanced by 3 H (3 horizontal periods) from a modulated signal supplied to the m-th retention capacitor in the previous subgroup.

Furthermore, a modulated signal supplied to the retention capacitor wire CSL0 changes from “Low” to “High” 3 H (3 horizontal periods) after the scanning signal line G1 starts being selected (scanned), a modulated signal supplied to the retention capacitor wire CSL1 changes from “High” to “Low” 2 H (2 horizontal periods) after the scanning signal line G2 starts being selected (scanned), and a modulated signal supplied to the retention capacitor wire CSL2 changes from “Low” to “High” 1 H (1 horizontal period) after the scanning signal line G3 starts being selected (scanned).

### Example 5

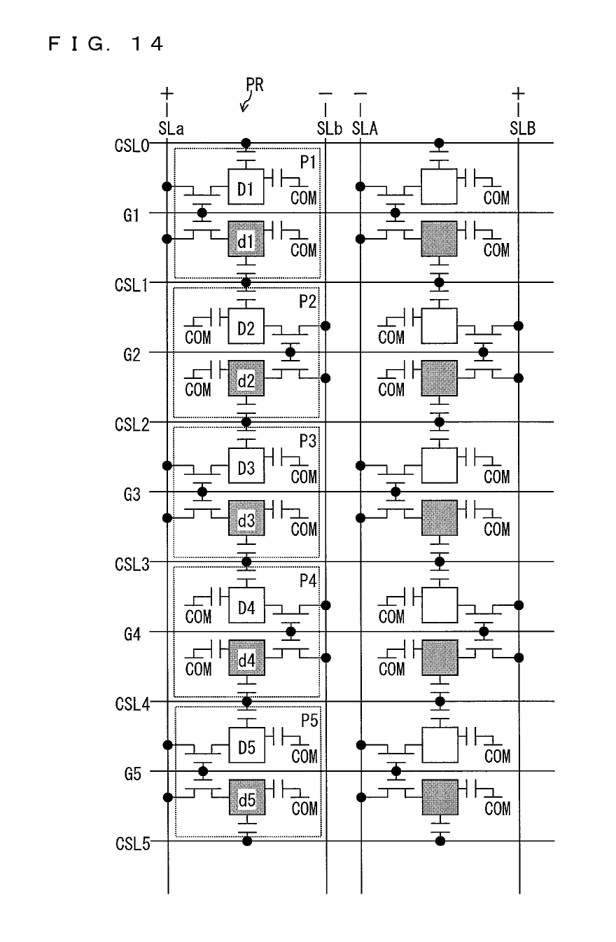

Example 5 employs, as illustrated in FIG. 14, an arrangement in which (i) data signal lines SLa, SLb, SLA, and SLB are arranged in this order and (ii) in a case where one of two pixels adjacent to each other along a row direction is connected to the data signal line SLa via two transistors, the other is connected to the data signal line SLA via two transistors, and, in a case where one of two pixels adjacent to each other along the row direction is connected to the data signal line SLb via two transistors, the other is connected to the data signal line SLB via two transistors. The data signal lines SLa, SLb, SLA, and SLB are supplied with positive, negative, negative, and positive signal potentials, respectively (see FIG. 14), or negative, positive, positive, and negative signal potentials, respectively.

### Example 6

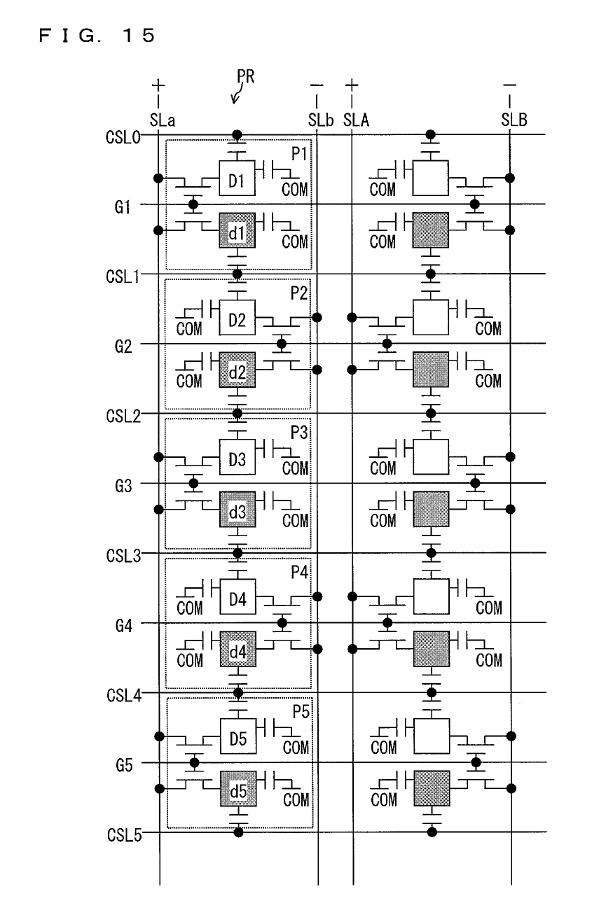

Example 6 employs, as illustrated in FIG. 15, an arrangement in which (i) data signal lines SLa, SLb, SLA, and SLB are arranged in this order and (ii) in a case where one of two pixels adjacent to each other along the row direction is connected to the data signal line SLa via two transistors, the other is connected to the data signal line SLB via two transistors, and, in a case where one of two pixels adjacent to each other along the row direction is connected to the data signal line SLb via two transistors, the other is connected to the data signal line SLA via two transistors. The data signal lines SLa, SLb, SLA, and SLB are supplied with positive, negative, positive, and negative signal potentials, respectively (see FIG. 15), or negative, positive, negative, and positive signal potentials, respectively.

### Example 7

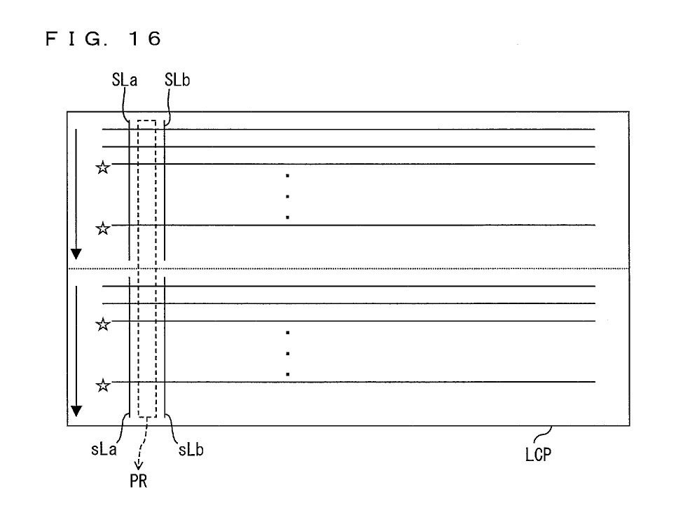

According to Example 7, a first half of the liquid crystal panel which is more upstream along the scanning direction and a second half which is more downstream along the scanning direction are scanned in parallel with each other. Specifically, as shown in FIG. 16, four data signal lines (e.g., data signal lines SLa and SLb corresponding to the first half and data signal lines sLa and sLb corresponding to the second half) are provided for one pixel column, and two scanning signal lines in the first half and two scanning signal lines in the second half (four scanning signal lines in total) are simultaneously scanned. With this configuration, it is possible to perform more high-speed driving.

As has been described, a liquid crystal display device of the present invention is a liquid crystal display device including: a first scanning signal line and a second scanning signal line which are adjacent to each other; a third scanning signal line which is not adjacent to the first scanning signal line; a first data signal line and a second data signal line; a first pixel, a second pixel, and a third pixel connected to the first scanning signal line, the second scanning signal line, and the third scanning signal line, respectively; and a first retention capacitor wire, a second retention capacitor wire, a third retention capacitor wire, and a fourth retention capacitor wire, wherein the first to third pixels each include a plurality of pixel electrodes, the first pixel with the first retention capacitor wire forms a capacitor, the first and second pixels with the second retention capacitor wire form capacitors, the third pixel with the third and fourth retention capacitor wires forms capacitors, potentials of the first and second retention capacitor wires are separately controlled, potentials of the third and fourth retention capacitor wires are separately controlled, and the first pixel receives a data signal from the first data signal line, and the second and third pixels receive a data signal from the second data signal line, and the first and third scanning signal lines are simultaneously selected.

With such a configuration in which the first scanning signal line and the third scanning signal line which is not adjacent to the first scanning signal line are simultaneously selected, it is possible to reduce a ripple that occurs in the second retention capacitor wire when the simultaneous selection of the first and third scanning signal lines ends so that the ripple is smaller than that in the case where, for example, the first and second scanning signal lines adjacent to each other are simultaneously selected. This makes it possible to suppress transverse lines of display unevenness.

The liquid crystal display device of the present invention can be configured such that a potential of each of the first and second retention capacitor wires periodically switches between two levels; and the first changes in potentials of the first and second retention capacitor wires after the simultaneous selection of the first and third scanning signal lines are opposite to each other.

The liquid crystal display device of the present invention can be configured such that a potential of each of the third and fourth retention capacitor wires periodically switches between two levels; and the first changes in potentials of the third and fourth retention capacitor wires after the simultaneous selection of the first and third scanning signal lines are opposite to each other.

The liquid crystal display device of the present invention can be configured such that potentials of the first and fourth retention capacitor wires are in phase with each other; and potentials of the second and third retention capacitor wires are in phase with each other.

The liquid crystal display device of the present invention can be configured such that the first and fourth retention capacitor wires are connected to one stem wire and the second and third retention capacitor wires are connected to another stem wire.

The liquid crystal display device of the present invention can be configured such that, assuming that (i) a cycle of changes in potential of each of the first to fourth retention capacitor wires is T (T is an integer of 2 or greater) times as long as one horizontal scanning period and (ii) k is an even multiple of T, k−2 scanning signal lines are provided between the first scanning signal line and the third scanning signal line.

The liquid crystal display device of the present invention can be configured such that two scanning signal lines are provided between the first scanning signal line and the third scanning signal line.

The liquid crystal display device of the present invention can be configured such that, in a case where (i) a cycle of changes in potential of each of the first to fourth retention capacitor wires is T (T is an integer of not less than 2) times as long as one horizontal scanning period and (ii) N, which is 2 or greater, is a submultiple of T, potentials of all retention capacitor wires including the first to fourth retention capacitor wires have N different phases.

The liquid crystal display device of the present invention can further include a first transistor, a second transistor, a third transistor, a fourth transistor, a fifth transistor, and a sixth transistor and can be configured such that: the first pixel includes a first pixel electrode and a second pixel electrode, the second pixel includes a third pixel electrode and a fourth pixel electrode, and the third pixel includes a fifth pixel electrode and a sixth pixel electrode; the first pixel electrode is connected to the first scanning signal line and the first data signal line via the first transistor, and the second pixel electrode is connected to the first scanning signal line and the first data signal line via the second transistor; the third pixel electrode is connected to the second scanning signal line and the second data signal line via the third transistor, and the fourth pixel electrode is connected to the second scanning signal line and the second data signal line via the fourth transistor; the fifth pixel electrode is connected to the third scanning signal line and the second data signal line via the fifth transistor, and the sixth pixel electrode is connected to the third scanning signal line and the second data signal line via the sixth transistor; and the first pixel electrode with the first retention capacitor wire forms a capacitor, the second and third pixel electrodes with the second retention capacitor wire form capacitors, the fifth pixel electrode with the third retention capacitor wire forms a capacitor, and the sixth pixel electrode with the fourth retention capacitor wire forms a capacitor.

The liquid crystal display device of the present invention can be configured such that, in one horizontal scanning period, polarity of a signal potential supplied from the first data signal line and polarity of a signal potential supplied from the second data signal line are different from each other.

A method for driving a liquid crystal panel of the present invention is a method for driving a liquid crystal panel including: a first scanning signal line and a second scanning signal line which are adjacent to each other; a third scanning signal line which is not adjacent to the first scanning signal line; a first data signal line and a second data signal line; a first pixel, a second pixel, and a third pixel connected to the first scanning signal line, the second scanning signal line, and the third scanning signal line, respectively; and a first retention capacitor wire, a second retention capacitor wire, a third retention capacitor wire, and a fourth retention capacitor wire, the first pixel to third pixels each including a plurality of pixel electrodes, the first pixel with the first retention capacitor wire forming a capacitor, the first and second pixels with the second retention capacitor wire forming capacitors, and the third pixel with the third and fourth retention capacitor wires forming capacitors, said method including: separately controlling potentials of the first and second retention capacitor wires and separately controlling potentials of the third and fourth retention capacitor wires; and supplying a data signal via the first data signal line to the first pixel, supplying a data signal via the second data signal line to the second and third pixels, and simultaneously selecting the first and third scanning signal lines.

The present invention is not limited to the descriptions of embodiments above, but may be altered by a skilled person within the scope of the claims. An embodiment based on a common general technical knowledge or a proper combination of such embodiments is encompassed in embodiments of the present invention.

### INDUSTRIAL APPLICABILITY

The present invention is suitable for a liquid crystal TV and a liquid crystal display.

### REFERENCE SIGNS LIST

P1 to P51 Pixels
CSL0 to CSL1080 Retention capacitor wires
G1 to G51 Scanning signal lines
LCD Liquid crystal display device
LCP Liquid crystal panel
PR Pixel column
SLa, SLb Data signal line

1. A liquid crystal display device comprising:
a first scanning signal line and a second scanning signal line which are adjacent to each other;
a third scanning signal line which is not adjacent to the first scanning signal line;
a first data signal line and a second data signal line;
a first pixel, a second pixel, and a third pixel connected to the first scanning signal line, the second scanning signal line, and the third scanning signal line, respectively; and
a first retention capacitor wire, a second retention capacitor wire, a third retention capacitor wire, and a fourth retention capacitor wire, wherein
the first to third pixels each include a plurality of pixel electrodes,
the first pixel with the first retention capacitor wire forms a capacitor,
the first and second pixels with the second retention capacitor wire form capacitors,
the third pixel with the third and fourth retention capacitor wires forms capacitors,
potentials of the first and second retention capacitor wires are separately controlled and potentials of the third and fourth retention capacitor wires are separately controlled, and
the first pixel receives a data signal from the first data signal line, the second and third pixels receive a data signal from the second data signal line, and the first and third scanning signal lines are simultaneously selected.

2. The liquid crystal display device as set forth in claim 1, wherein:
a potential of each of the first and second retention capacitor wires periodically switches between two levels; and
the first changes in potentials of the first and second retention capacitor wires after the simultaneous selection of the first and third scanning signal lines are opposite to each other.

3. The liquid crystal display device as set forth in claim 1, wherein:
a potential of each of the third and fourth retention capacitor wires periodically switches between two levels; and
the first changes in potentials of the third and fourth retention capacitor wires after the simultaneous selection of the first and third scanning signal lines are opposite to each other.

4. The liquid crystal display device as set forth in claim 1, wherein:
potentials of the first and fourth retention capacitor wires are in phase with each other; and
potentials of the second and third retention capacitor wires are in phase with each other.

5. The liquid crystal display device as set forth in claim 4, wherein:
the first and fourth retention capacitor wires are connected to one stem wire; and
the second and third retention capacitor wires are connected to another stem wire.

6. The liquid crystal display device as set forth in claim 1, wherein, assuming that (i) a cycle of changes in potential of each of the first to fourth retention capacitor wires is T (T is an integer of 2 or greater) times as long as one horizontal scanning period and (ii) k is an even multiple of T, k−2 scanning signal lines are provided between the first scanning signal line and the third scanning signal line.

7. The liquid crystal display device as set forth in claim 1, wherein two scanning signal lines are provided between the first scanning signal line and the third scanning signal line.

8. The liquid crystal display device as set forth in claim 1, wherein, in a case where (i) a cycle of changes in potential of each of the first to fourth retention capacitor wires is T (T is an integer of not less than 2) times as long as one horizontal scanning period and (ii) N, which is 2 or greater, is a submultiple of T, potentials of all retention capacitor wires including the first to fourth retention capacitor wires have N different phases.

9. A liquid crystal display device as set forth in claim 1, further comprising a first transistor, a second transistor, a third transistor, a fourth transistor, a fifth transistor, and a sixth transistor, wherein:
the first pixel includes a first pixel electrode and a second pixel electrode, the second pixel includes a third pixel electrode and a fourth pixel electrode, and the third pixel includes a fifth pixel electrode and a sixth pixel electrode;
the first pixel electrode is connected to the first scanning signal line and the first data signal line via the first transistor, and the second pixel electrode is connected to the first scanning signal line and the first data signal line via the second transistor;
the third pixel electrode is connected to the second scanning signal line and the second data signal line via the third transistor, and the fourth pixel electrode is connected to the second scanning signal line and the second data signal line via the fourth transistor;
the fifth pixel electrode is connected to the third scanning signal line and the second data signal line via the fifth transistor, and the sixth pixel electrode is connected to the third scanning signal line and the second data signal line via the sixth transistor; and
the first pixel electrode with the first retention capacitor wire forms a capacitor, the second and third pixel electrodes with the second retention capacitor wire form capacitors, the fifth pixel electrode with the third retention capacitor wire forms a capacitor, and the sixth pixel electrode with the fourth retention capacitor wire forms a capacitor.

10. The liquid crystal display device as set forth in claim 1, wherein, in one horizontal scanning period, a polarity of a signal potential supplied from the first data signal line and a polarity of a signal potential supplied from the second data signal line are different from each other.

11. A method for driving a liquid crystal panel, the liquid crystal panel including: a first scanning signal line and a second scanning signal line which are adjacent to each other; a third scanning signal line which is not adjacent to the first scanning signal line; a first data signal line and a second data signal line; a first pixel, a second pixel, and a third pixel connected to the first scanning signal line, the second scanning signal line, and the third scanning signal line, respectively; and a first retention capacitor wire, a second retention capacitor wire, a third retention capacitor wire, and a fourth retention capacitor wire, the first pixel to third pixels each including a plurality of pixel electrodes, the first pixel with the first retention capacitor wire forming a capacitor, the first and second pixels with the second retention capacitor wire forming capacitors, and the third pixel with the third and fourth retention capacitor wires forming capacitors,
said method comprising:
separately controlling potentials of the first and second retention capacitor wires and separately controlling potentials of the third and fourth retention capacitor wires; and
supplying a data signal via the first data signal line to the first pixel, supplying a data signal via the second data signal line to the second and third pixels, and simultaneously selecting the first and third scanning signal lines.
